(19) United States
(12) Patent Application Publication
(10) Pub. No.: US 2002/0038577 A1
(43) Pub. Date: Apr. 4, 2002

(54) Pedalry and pedal system with a multiple of such pedalries

(76) Inventors: Richard Bialk, Grundau (DE); Marcus Fuhrer, Bad Nauheim (DE); Peter Kavermann, Frankfurt (DE); Eric Merlin, Feldkirchen (DE)

Correspondence Address: FROMMER LAWRENCE & HAUG LLP, 745 Fifth Avenue, New York, NY, 10151, US

(21) Appl. No.: 09/867,720

(22) Filed: May 29, 2001

(30) Foreign Application Priority Data
May 30, 2000 (DE) 100 26 751.3

(51) Int. Cl. G05G 1/14

(52) U.S. Cl. 74/512

(57) ABSTRACT

The invention concerns a motor vehicle pedalry with a slue or swing unit as well as a displacement or adjusting unit between a step plate and a transfer, amplification and/or sensing unit whereby the rest position of the step plate is changeable via the slue or swing unit and/or via the displacement or adjusting unit, the pedal transfer before and the pedal transfer after a change in the rest position of the step plate are not essentially different, and the rest position of the step plate is adapted to the body mass of a driver rotationally via the slue or swing unit and translationally via the displacement or adjusting unit; and a pedal system with a multiple of such pedalries.

The current invention concerns a motor vehicle pedalry with a slue or swing unit and a displacement unit between a step plate and a transfer, amplifying and/or sensing unit in which the step plate rest position is changeable by means of the slue or swing unit and/or the displacement unit and the pedal transfer before and the pedal transfer after a change in the step plate rest position are not significantly different; and a pedal system including a multiple of such pedalries.

Step plate “rest position” means the position that the step plate assumes without the action of external force for braking, giving gas, clutching, or similar action.

A pedalry of this type is known from DE 198 20 542 A1, in which the displacement or adjusting unit includes a self-inhibiting displacement or adjusting mechanism integrated into the slue or swing unit, which includes a lever parallelogram, and the drive of which is also either attached to the pedalry or at least partially decoupled to a fixed-mount carrier. With the known pedalry a base lever with step plate for changing the rest position of the step plate allows itself to slue or swing without influencing the pedal transmission in operating the pedalry for braking, giving gas, clutching, or similar action.

Further there are numerous additional pedalries for the swinging away or slueing or swinging of a base lever with step plate for the purpose of reducing danger in the event of accidents; we refer in this connection for example to DE 196 16 845 A1.

From DE 39 41 401 C1 a device for fixing a hydraulic unit in a motor area of the vehicle is known, which has a rivet functioning as a breaking point in the event of a crash for fixing to the motor vehicle body.

The risk of injury to the driver from the pedalry, especially in frontal accidents, nonetheless remains unsatisfactorily high. The rest position of the pedalry, which is not adjusted to the exact body mass of a driver, is especially apt to cause injuries due to abnormal posture of the driver, for example to the back of the neck, in the event of frontal accident and the release of an airbag. Moreover, a pedalry not adjusted to the driver's body mass can lead to driver discomfort, which is preferably to be avoided.

Thus it is the task of the present invention to further develop this type of pedalry in such a manner that the disadvantages of the current state of the art are overcome, especially in such a way that an exact adjustment of the rest position of the step plate to the respective driver of a motor vehicle is possible. In an accident, the pedalry is also not to move into the driver area toward the driver.

The task of the invention is solved in that the rest position of the step plate is adjustable to adapt to the body mass of a driver rotationally by means of the slue or swing unit and translationally by means of the displacement or adjusting unit.

It is also intended that the displacement or adjusting unit and the slue or swing unit are lockable and/or self-inhibiting, and a pedal force applied to the step plate can be transferred to the fixed-mount transfer, amplifying, and/or sensing unit essentially independently of the locked and/or inhibited setting of the slue or swing unit as well as of the displacement or adjusting unit.

Further developments of the invention are characterized by the fact that the displacement or adjusting unit is fixed-mounted and attaches to the non-fixed-mounted slue or swing unit.

It is thus recommended in the sense of the invention that the step plate is mounted to a first end of a base lever of the slue or swing unit, and the displacement or adjusting unit attaches to the second end of the base lever, opposite the step plate.

It is also intended that the slue or swing unit includes a lever system, a shear connection and/or a double eccentric arrangement.

It is preferred that the lever system comprises at least one lever parallelogram, preferably a double lever parallelogram.

According to the invention it can further be anticipated that the lever system has at least one wrist point on the base lever, a free turning point, a wrist point to the transfer, amplification, and/or sensing unit, especially on a coupling rod to the transfer, amplification, and/or sensing unit, and a suspension point to the car body of the motor vehicle.

It is preferred that the lever system has two wrist points on the base lever, two free turning points, one wrist point to the transfer, amplification and/or sensing unit and a suspension point to the car body, whereby preferably the two free turning points are arranged between the two wrist points on the base lever on the one hand and between the wrist point to the transfer, amplification and/or sensing unit and the mounting point to the car body on the other.

A first rigid member between the suspension point to the car body and a suspension point on the car body and a second rigid member between at least one wrist point to the base lever and a translation point of the displacement or adjusting unit is recommended in the invention, whereby a movement of the first rigid member relative to the second rigid member in the event of a car body deformation, especially in an accident situation, to a specific extent such as a translation of up to ca. 100 mm of the car body firewall, essentially does not force the base lever and step plate of the car body in the direction of the driver. Preferably the first rigid member is inclined relative to the second rigid member.

Further, it can advantageously be constructed such that the lever system has pre-tension which loads at least the one free turning point in a chosen direction, especially in the direction of a car body intermediate wall inclined relative to the car body firewall.

According to the invention it is also recommended that the maximum translation realm of the displacement or adjusting unit is smaller than the geometric maximum translation of the rest position of the step plate.

According to the invention it can also be anticipated that a variety of step plate rest positions can be set, memorized and/or recalled, especially in relationship to a steering wheel and/or driver seat position.

Preferred forms of the invention are further characterized by at least one breaking position in the slue or swing unit and/or the displacement or adjusting unit which breaks at a certain threshold load, especially in an accident situation, for example with a load which would lead to a car body firewall translation of more than ca. 100 mm, whereby the step plate and/or the base lever, at least after a break of the breaking position, essentially does/do not move away from the car body toward the driver.

The invention further concerns a pedal system with a variety of pedalries according to the invention.

It is understood according to the invention that the multiple pedalries are based on a single displacement or adjusting unit.

This invention is based on the surprising recognition that an optimized adaptation of the rest position of a motor vehicle pedalry step plate to the body mass of a driver is possible only if the pedalry is displaceable in a rest position, rotationally as well as translationally, for example toward the car body and away from the driver, without influencing the kinematics of the pedalry as such. In other words, according to the invention the force which is introduced via the pedalry into a transfer, amplification, and/or sensing unit does not represent a slueing or swinging and/or a displacement function of the step plate, which nonetheless serves comfort as well as the safety of the driver and thus increases overall driving quality. The units required for the adaptation of the rest position, i.e. a slue or swing unit and a displacement or adjusting unit for the translational displacement, are preferably decoupled from each other, both attaching however to a base lever, to which the step plate is attached. The displacement or adjusting unit is preferably fixed-mounted while the slue or swing unit is integrated into the movable parts of the pedalry.

For further crash safety the pedalry according to the invention also assures that in a frontal accident involving car body displacement in the direction of the driver area the base lever with the step plate will not be forced into the driver area. This is made possible on the one hand by means of a special suspension of the slue or swing unit as well as a special attachment of the displacement or adjusting unit to the car body. On the other hand, one or more breaking points can be arranged between the step plate and the car body; in the event of a frontal accident these breaking points lead to a dissolution of the connection between the car body and the step plate. Both crash safeties can complement each other since preferably they deploy in the event of different loads to the car body.

Further characteristics and advantages of the invention result from the following description in which two forms of the invention are explained in detail on the basis of schematic diagrams. They show:

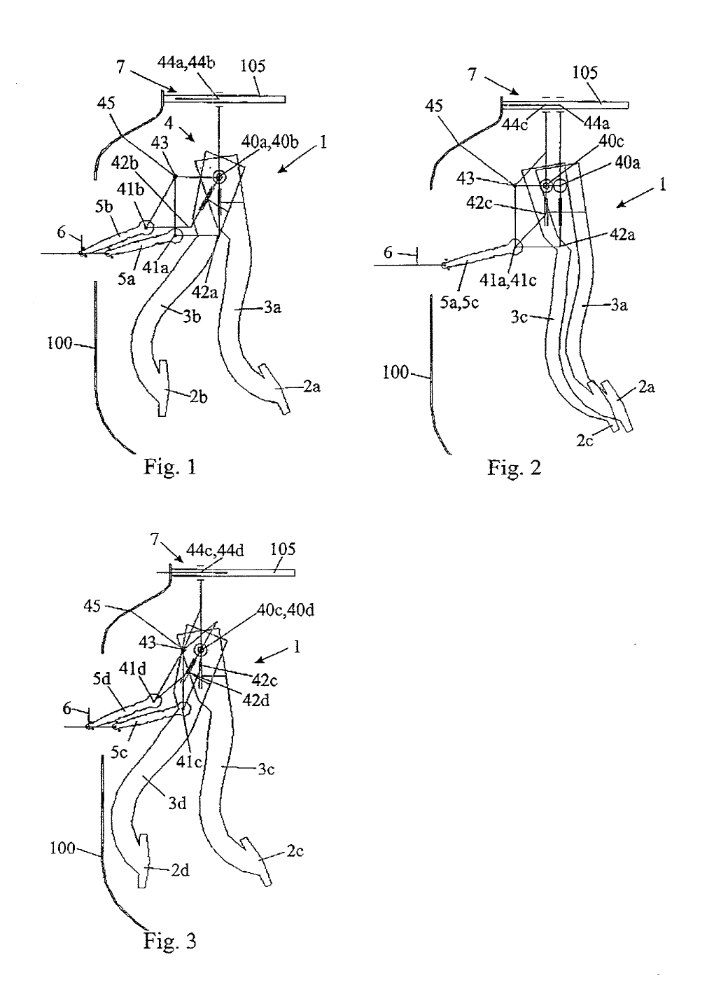

FIG. 1 a cross section through a first form of the pedalry according to the invention in two rest positions, namely first in its zero position and secondly turned by 30 degrees;

FIG. 2 a view as FIG. 1, first with the pedalry in its zero position and then after a translation of 22 mm;

FIG. 3 a view as in FIG. 1 or FIG. 2, respectively, first after a translation of 40 mm and second after a translation of 40 mm as well as a turn of 30 degrees;

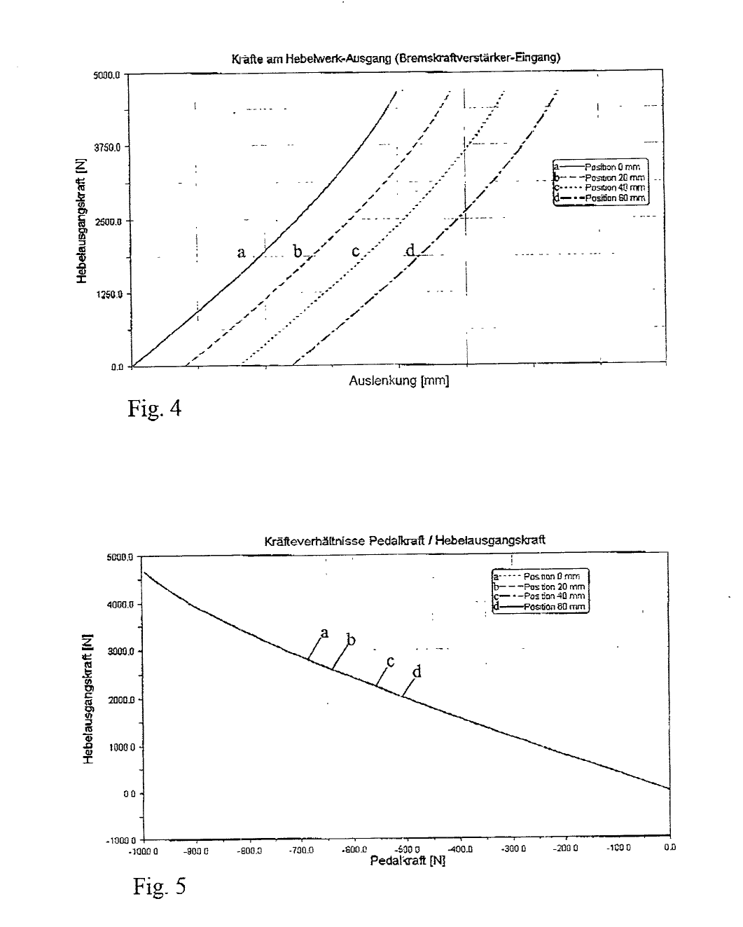

FIG. 4 a graph in which the force at the exit of the pedalry is applied against a displacement, with an initial displacement of 0 mm, 20 mm, 40 mm and 60 mm, respectively;

FIG. 5 a graph in which the applied pedal force is applied against the exit force of the pedalry with an initial displacement of 0 mm, 20 mm, 40 mm, 60 mm, respectively;

Starting from a zero position, indicated by the letter “a”, base lever 3a also allows itself to be turned via slue or swing unit 4 in the direction of the car body firewall 100 around the wrist point 40a, 40b, whereby the turned position is indicated by the letter “b”, see FIG. 1. As it turns, the geometry of the lever system changes, including the position of the coupling rod 5a or 5b, respectively, however not the lever relationship between the base lever 3a or 3b, respectively, and coupling rod 5a or 5b, respectively.

Starting from the zero position base lever 3a allows itself to be translated also in the direction of the car body firewall 100; the translated position is indicated by the letter “c”. In FIG. 2, such a translation of the base lever 3a or 3c, respectively, is shown, whereby for the translation the base lever 3a or 3c, respectively, is moved over the displacement or adjusting unit 7 by means of displacement of translation point 44a or 44c, respectively, toward the car body firewall 100, whereby the lever system deforms, however neither the position of the coupling rod 5a or 5c, respectively, nor the transmission of the pedalry 1 is altered. This is clear from the graphic representations of FIGS. 4 and 5 which show first the forces on the lever exit, i.e. on the coupling rod, in various relative translated rest positions, with 0, 20, 40 and 60 mm displacement, respectively, of the step plate, and second the force relationships of entry force, i.e. the force applied to the step plate or base lever, respectively, to the exit force, i.e. the force transferred to the coupling rod in various translated rest positions with 0, 20, 40 and 60 mm displacement, respectively.

Clearly base lever 3a can also for example first be turned and then translated from its zero position, as indicated by the letter “d” and shown in FIG. 3. The final rest position of base lever 3d and of step plate 2d, which are adjusted to the body mass of a driver (not shown), is set to be self-inhibiting, so that with activation of the pedalry 1, be it for braking, clutching, or giving gas, the pedal transfer independent of the individual setting of the rest position via slue or swing unit 4 and/or displacement or adjusting unit 7 leads to the vehicle handling desired by the driver.

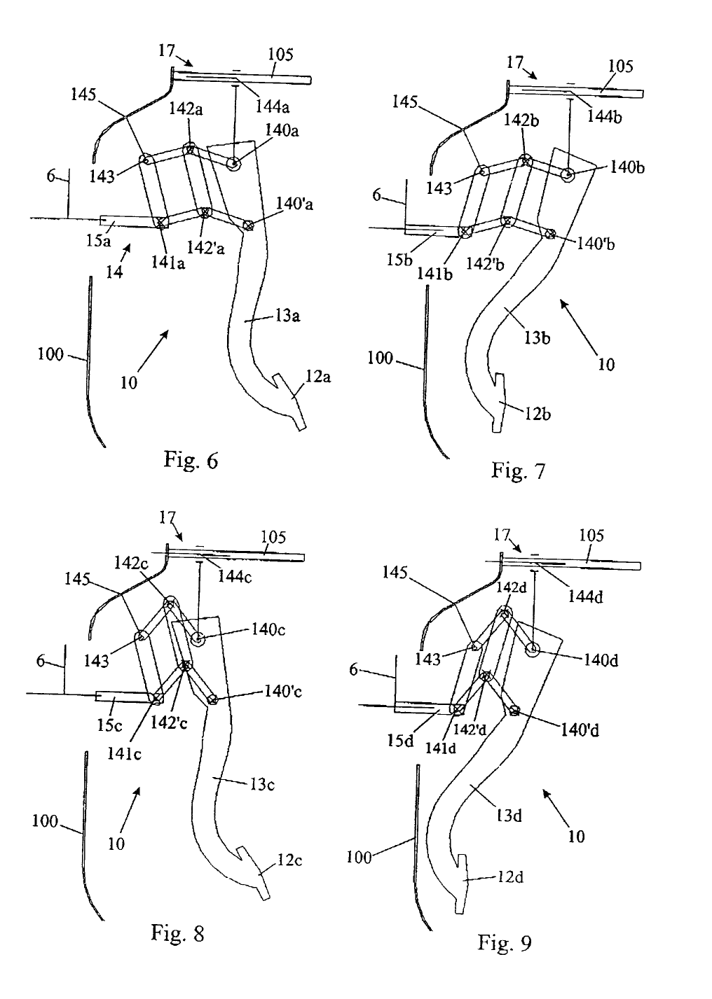

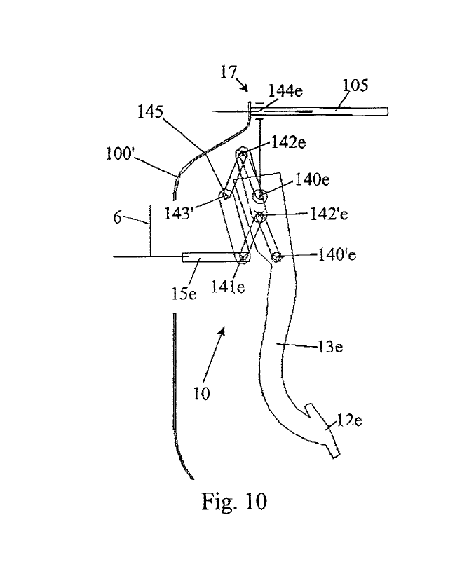

A second form of the pedalry 10 according to the invention, shown in FIGS. 6 through 10, differs from that in FIGS. 1 through 3 in the concrete form of a slue or swing unit 14. Again, a step plate 12a, 12b, 12c, 12d, 12e is attached to one end of a base lever 13a, 13b, 13c, 13d, 13e, which on its other end is operationally connected whereby the slue or swing unit 14 is attached via a coupling rod 15a, 15b, 15c, 15d, 15e with a fixed-mount transfer, amplifying and/or sensing unit 6 and the displacement or adjusting unit is itself a fixed mount. The slue or swing unit 14 has in addition to an initial wrist point 140a, 140b, 140c, 140d, 140e on the base lever 13a, 13b, 13c, 13d, 13e, to which also the displacement or adjusting unit 17 attaches, a second wrist point 140′a, 140′b, 140′c, 140′d, 140′e on the base lever 13a, 13b, 13c, 13d, 13e. Further, the following are intended: between a suspension point 143 to the car body firewall 100 and a wrist point 141a, 141b, 141c, 141d, 141e on the coupling rod 15a, 15b, 15c, 15d, 15e on the one hand, and the wrist points 140a, 140b, 140c, 140d, 140e, 140′a, 140′b, 140′c, 140′d, 140′e on the base lever 13a, 13b, 13c, 13d, 13e on the other hand, two free turning points 142a, 142b, 142c, 142d, 142e, 142′a, 142′b, 142′c, 142′d, 142′e, which simultaneously also represent the contact points of two lever parallelograms for the formation of a double lever parallelogram of the slue or swing unit 14. Between the suspension point 143 and a related suspension point 145 on the car body firewall 100 a first rigid member is intended; and between the first wrist point 140a, 140b, 140c, 140d, 140e on the base lever 13a, 13b, 13c, 13d, 13e, and a translation point 144a, 144b, 144c, 144d, 144e of the displacement or adjusting unit 17 on a car body intermediate wall 105, which is inclined toward the car body firewall 100, a second rigid member is intended.

Pedalry 10 of FIGS. 6 to 10 is described below in its manner of functioning:

From a zero position, shown in FIG. 6 and indicated by the letter “a”, base lever 13a allows itself to be turned by 30 degrees around wrist point 140a in the direction of the car body firewall 100 in order to achieve the position depicted in FIG. 7 and indicated with the letter “b”. In the process of turning there is a deformation of the double lever parallelograms of the slue or swing unit 14 as well as a displacement of the coupling rod 15a or 15b, respectively, without affecting the transfer of the pedalry 10.

From the zero position according to FIG. 6 base lever 13a also allows itself to be translated toward the car body firewall 100, for example by 40 mm, as shown in FIG. 8 and designated by the letter “c”. In the process of translation there is a deformation of translation point 144a or The characteristics of the invention as disclosed in the above description, in the drawings and in the claims of the invention, can be significant individually as well as in any combination for the realization of the invention in its various forms.

### List of Reference Designations

1 Pedalry

2b, 2c, 2d Step plate

3b, 3c, 3d Base lever

4 Slue or swing unit

5b, 5c, 5d Coupling rod

6 Transfer, amplification, and/or sensing unit

7 Displacement or adjusting unit

10 Pedalry

12a, 12b, 12c, 12d, 12e Step plate

13a, 13b, 13c, 13d, 13e Base lever

14 Slue or swing unit

15a, 15b, 15c, 15d, 15e Coupling rod

17 Displacement or adjusting unit

40a, 40b, 40c, 40d Wrist point

41a, 41b, 41c, 41d, Wrist point

42a, 42b, 42c, 42d Turning point

43 Suspension point

44a, 44b, 44c, 44d Translation point

45 Suspension point

100, 100′ Car body firewall

105 Car body intermediate wall

140a, 140b, 140c, 140d, 140e Wrist point

140′a, 140′b, 140′c, 140′d, 140′e Wrist point

141a, 141b, 141c, 141d, 141e Wrist point

142a, 142b, 142c, 142d, 142e Turning point

142′a, 142′b, 142′c, 142′d, 142′e Turning point

143 Suspension point

144a, 144b, 144c, 144d, 144e Translation point

145 Mounting point

1. Pedalry for a motor vehicle with a slue or swing unit as well as a displacement or adjusting unit between a step plate and a transfer, amplification, or sensing unit, whereby the rest position of the step plate is changeable via the slue or swing unit and/or the displacement or adjusting unit, and the pedal transfer before as well as the pedal transfer after a change of the rest position of the step plate are essentially not different from one another and are characterized by the fact that the rest position of the step plate (2a, 2b, 2c, 2d, 12a, 12b, 12c, 12d, 12e) is adjustable to adapt to the body mass of a driver rotationally via the slue or swing unit (4, 14) and translationally via the displacement or adjusting unit (7, 17).

2. Pedalry according to claim 1 characterized by the fact that the displacement or adjusting unit (7, 17) and the slue or swing unit (4, 14) are lockable and/or self-inhibiting, and a pedal force applied to the step plate (2a, 2b, 2c, 2d, 12a, 12b, 12c, 12d, 12e) essentially independently of the locked and/or inhibited setting of the slue or swing unit (7, 17) as well as of the displacement or adjusting unit (4, 14) is transferable to the motor vehicle fixed-mount transfer, amplification and/or sensing unit (6).

3. Pedalry according to claim 1 or 2 characterized by the fact that the displacement or adjusting unit (7, 17) is fixed-mounted and attaches to the non-fixed-mount slue or swing unit (4, 14).

4. Pedalry according to claim 3 characterized by the fact that the step plate (2a, 2b, 2c, 2d, 12a, 12b, 12c, 12d, 12e) is attached to a first end of a base lever (3a, 3b, 3c, 3d, 13a, 13b, 13c, 13d, 13e) of the slue or swing unit (4, 14), and the displacement or adjusting unit (7, 17) attaches to the second end of the base lever (3a, 3b, 3c, 3d, 13a, 13b, 13c, 13d, 13e) opposite the step plate (2a, 2b, 2c, 2d, 12a, 12b, 12c, 12d, 12e).

5. Pedalry according to one of the above claims characterized by the fact that the slue or swing unit (4, 14) includes a lever system, a shear connection and/or a double eccentric arrangement.

6. Pedalry according to claim 5 characterized by the fact that the lever system includes at least one lever parallelogram, preferably a double lever parallelogram.

7. Pedalry according to claim 5 or 6 characterized by the fact that the lever system has at least one wrist point (40a, 40b, 40c, 40d, 140a, 140b, 140c, 140d, 140e, 140′a, 140′b, 140′c, 140′d, 140′e) on the base lever (3a, 3b, 3c, 3d, 13a, 13b, 13c, 13d, 13e), a free turning point (42a, 42b, 42c, 42d, 142a, 142b, 142c, 142d, 142e, 142′a, 142′b, 142′c, 142′d, 142′e), a wrist point (41a, 41b, 41c, 41d, 141a, 141b, 141c, 141d, 141e) to the transfer, amplification, and/or sensing unit (6), especially on a coupling rod (5a, 5b, 5c, 5d, 15a, 15b, 15c, 15d, 15e) to the transfer, amplification and/or sensing unit (6) and a suspension point (43, 143) to the car body (100, 100′) of the motor vehicle.

8. Pedalry according to claim 7 characterized by the fact that the pedal system has two wrist points (140a, 140b, 140c, 140d, 140e, 140′a, 140′b, 140′c, 140′d, 140′e) on the base lever (13a, 13b, 13c, 13d, 13e), two free turning points (142a, 142b, 142c, 142d, 142e, 142′a, 142′b, 142′c, 142′d, 142′e), one wrist point (141a, 141b, 141c, 141d, 141e) to the transfer, amplification, and/or sensing unit (6) and a suspension point (143) to the carbody (100, 100′), whereby preferably the two free turning points (142a, 142b, 142c, 142d, 142e, 142′a, 142′b, 142′c, 142′d, 142′e) are arranged on the one hand between the two wrist points (140a, 140b, 140c, 140d, 140e, 140′a, 140′b, 140′c, 140′d, 140′e) on the base lever (13a, 13b, 13c, 13d, 13e) and on the other hand between the wrist point (141a, 141b, 141c, 141d, 141e) to the transfer, amplification, and/or sensing unit (6) and the mounting point (143) to the car body (100, 100′).

9. Pedalry according to one of the claims 7 to 8 characterized by a first rigid member between the suspension point (43, 143) to the car body (100, 100′) and a suspension point (45, 145) to the car body (100, 100′) and a second rigid member between at least one wrist point (40a, 40b, 40c, 40d, 140a, 140b, 140c, 140d, 140e, 140′a, 140′b, 140′c, 140′d, 140′e) to the base lever (3a, 3b, 3c, 3d, 13a, 13b, 13c, 13d, 13e) and a translation point (44a, 44b, 44c, 44d, 144a, 144b, 144c, 144d, 144e) of the displacement or adjusting unit (7, 17) whereby a movement of the first rigid member relative to the second rigid member in the event of a car body deformation, especially in an accident situation, up to a given degree, as up to a translation of ca. 100 mm of the car body firewall (100′) essentially does not force the base lever (3a, 3b, 3c, 3d, 13a, 13b, 13c, 13d, 13e) and the step plate (2a, 2b, 2c, 2d, 12a, 12b, 12c, 12d, 12e) from the car body (100, 100′, 105) in the direction of a driver and preferably the first rigid member is inclined relative to the second rigid member.

10. Pedalry according to claim 7 or 8 characterized by the fact that the lever system has a pre-tension which loads at least one free turning point (42a, 42b, 42c, 42d, 142a, 142b, 142c, 142d, 142e, 142′a, 142′b, 142′c, 142′d, 142′e) in a chosen direction, especially in the direction of a car body intermediate wall which is inclined relative to the car body firewall.

11. Pedalry according to one of the above claims characterized by the fact that the maximal translation realm of the displacement or adjusting unit (7, 17) is smaller than the geometric maximum translation of the rest position of the step plate (2a, 2b, 2c, 2d, 12a, 12b, 12c, 12d, 12e).

12. Pedalry according to one of the previous claims characterized by the fact that multiple step plate rest positions (2a, 2b, 2c, 2d, 12a, 12b, 12c, 12d, 12e) can be set, memorized and/or recalled, especially in relationship to a steering wheel and/or driver seat position.

13. Pedalry according to one of the above claims characterized by at least one breaking position in the slue or swing unit and/or the displacement or adjusting unit, which breaks in the event of a certain threshold load, especially in an accident situation, as in a load which would lead to a translation of the car body firewall of more than ca. 100 mm, whereby the step plate and/or the base lever at least after a break of the breaking point essentially do not move away from the car body toward the driver.

14. Pedal system with a multiple of pedalries according to one of the above claims.

15. Pedal system according claim 14 characterized by the fact that the multiple pedalries are based on a single displacememt or adjusting unit.
